(19) United States
(12) Patent Application Publication
(10) Pub. No.: US 2011/0228093 A1
(43) Pub. Date: Sep. 22, 2011

(54) VIDEO CAMERA MONITORING SYSTEM AND CAMERA MONITORING METHOD THEREOF

(75) Inventor: Ming-Chih Hsieh, Tu-Cheng (TW)

(73) Assignee: HON HAI PRECISION INDUSTRY CO., LTD., Tu-Cheng (TW)

(21) Appl. No.: 12/755,381

(22) Filed: Apr. 6, 2010

(30) Foreign Application Priority Data
Mar. 17, 2010 (TW) 99107729

(51) Int. Cl. H04N 7/18

(52) U.S. Cl. 348/159; 348/E07.085

(57) ABSTRACT

A video camera monitoring system includes one or more cameras, a controller, a computer, a computer monitor, a video encoder, and one or more camera monitors. The cameras capture images and convert the captured images into video signals. The controller transfers the video signals to the computer. The computer monitor displays video images corresponding to the video signals. The computer selects a section of each of the video images and sends video signals corresponding to the section of each of the video images back to the controller. The controller compresses the video signals from the computer and transfers the compressed video signals to the video encoder. The video encoder encodes the compressed video signals into analog video signals. The camera monitors receive the analog video signals and display the video images of the analog video signals.

### BACKGROUND

1. Technical Field

The present disclosure relates to camera monitoring systems and camera monitoring methods, and particularly, to a video camera monitoring system and method.

2. Description of Related Art

Nowadays, cameras are very widely used in places such as offices, homes, or public areas, to camera monitor the activities being taken place in these places in real time. A common camera monitoring system may include a number of cameras set in various locations, a controller, a video encoder, and a number of camera monitors. The controller receives video signals from the cameras and compresses these video signals, and then transfers the compressed video signals to the video encoder, which encodes them to analog video signals and sends them to the camera monitors.

Sometimes, certain sections of these video images need to be enlarged. However, the sections of the video image that is enlarged from the analog video signal are sometimes blurry. Therefore there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of an embodiment of a video camera monitoring system.

FIG. 2 is a flowchart of an embodiment of a video camera monitoring method.

### DETAILED DESCRIPTION

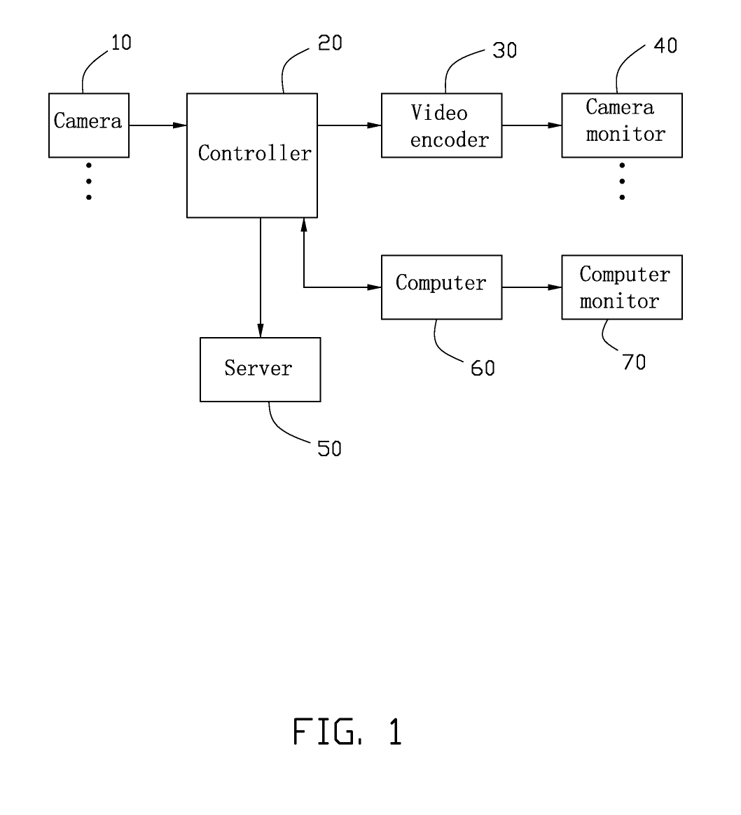

Referring to FIG. 1, an embodiment of a video camera monitoring system includes a plurality of cameras 10 each with a million or more pixels, a controller 20, a video encoder 30, a plurality of camera monitors 40 designated correspondingly to the plurality of cameras 10, a remote data server 50, a computer 60, and a computer monitor 70. The number of the cameras 10 is equal to the number of the camera monitors 40. The cameras 10 are placed in various locations, such as different areas/rooms in a building, to capture images and convert the captured images into video signals. The camera monitors 40 are arranged in a camera monitoring room, in a rack on a wall. The camera monitors 40 are designated to corresponding cameras 10, namely each camera monitor 40 displays a video image captured by a corresponding camera 10.

The controller 20 connects to the cameras 10, to receive the video signals from the cameras 10. The controller 10 also connects to the video encoder 30, the server 50, and the computer 60. The controller 10 compresses the video signals and then transfers the compressed video signals to the server 50, which acts as a backup storage for the video signals. At the same time the controller 20 transfers the video signals to the computer 60.

The computer 60 displays video images corresponding to the video signals through a video software and the computer monitor 70. Users can select a section of the video image from any of the video images with the video software, and then the computer 60 sends the video signals corresponding to the section of the video images back to the controller 20. The selected section of the video images to be camera monitored, such as a specific spot/point in an area/room, can be changed at anytime. After users select the section of the video image to be camera monitored, the controller 10 compresses the video signals from the computer 60 and transfers the compressed section of the video signals to the video encoder 30. The video encoder 30 encodes the compressed section of the video signals into analog video signals. The camera monitors 40, may use National Television Systems Committee (NTSC) or Phase Alternating Line (PAL) systems, receive the analog video signals and display the video images of the analog video signals. The camera monitors 40 will always display the selected section of the video images until users change the selection.

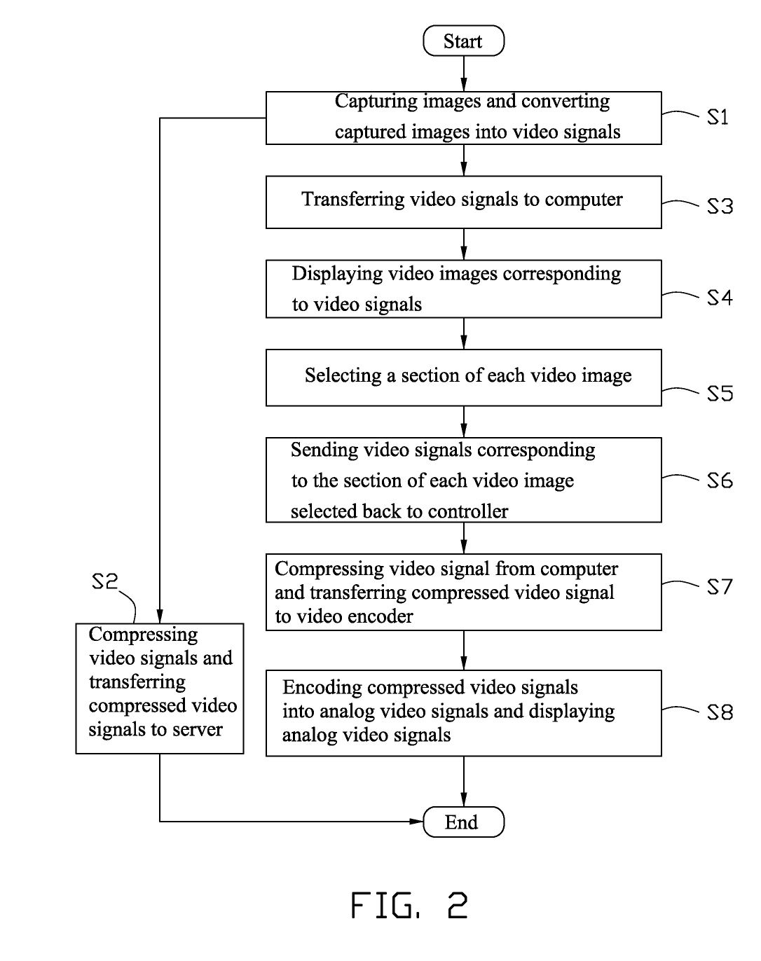

Referring to FIG. 2, an embodiment of a video camera monitoring method includes the following steps.

Step S1, the cameras 10 captures images and converts the captured images into video signals.

Step S2, the controller 20 receives the video signals from the cameras 10 and compresses the video signals, and then transfers the compressed video signals to the server 50, the server 50 is a backup storage.

Step S3, the controller 20 transfers the captured video signals to the computer 60.

Step S4, the computer 60 displays video images corresponding to the captured video signals through the video software and the computer monitor 70.

Step S5, the computer 60 receives control signals by users (using computer mouse to input the control signals, for example) to select a section of each video image with the video software.

Step S6, the computer 60 sends the video signals corresponding to the section of the video image selected back to the controller 20 with the video software.

Step S7, the controller 10 compresses the video signals from the computer 60 and transfers the compressed video signals to the video encoder 30.

Step S8, the video encoder 30 encodes the compressed video signals into analog video signals, and outputs the analog video signals to the camera monitors 40 to receive a real time display the section of the video image that has been selected.

Because the cameras 10 have a million or more pixels, when the video signals corresponding to the section of the video image are compressed and encoded into analog video signals, the video images displayed on the camera monitors 40 are very clear.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A video camera monitoring system comprising:
a plurality of cameras to capture images and convert the captured images into video signals;
a controller connected to the plurality of cameras, to receive the video signals;
a computer connected to the controller, to receive the video signals through the controller;
a computer monitor connected to the computer, to display video images corresponding to the video signals, wherein the computer selects a section of each of the video images and sends video signals corresponding to the section of the video images back to the controller;
a video encoder connected to the controller, wherein the controller compresses the video signals from the computer and transfers the compressed video signals to the video encoder, the video encoder encodes the compressed section of the video signals into analog video signals; and
a plurality of camera monitors designated correspondingly to the plurality of cameras, wherein the plurality of camera monitors receive the analog video signals and display the video images of the analog video signals.

2. The video camera monitoring system of claim 1, further comprising a remote data server connected to the controller, wherein the controller compresses the video signals from the plurality of cameras and then transfers the compressed video signals to the remote data server.

3. The video camera monitoring system of claim 1, wherein the plurality of cameras each having a million or more pixels.

4. A video camera monitoring method comprising:
capturing images and converting the captured images into video signals through a plurality of cameras;
transferring the captured video signals to a computer;
displaying video images corresponding to the captured video signals;
selecting a section of each of the video images;
sending the video signals corresponding to the section of each of the video images back to a controller;
compressing the video signals from the computer and transferring the compressed video signals to a video encoder; and
encoding the compressed video signals into analog video signals and displaying the analog video signals.

5. The video camera monitoring method of claim 4, further comprising:
compressing the captured video signals and transferring the compressed captured video signals to a backup server.

6. The video camera monitoring method of claim 4, wherein the plurality of cameras each having a million or more pixels.
